(19) United States
(12) Patent Application Publication
(10) Pub. No.: US 2011/0144550 A1
(43) Pub. Date: Jun. 16, 2011

(54) Apparatus and method for loosening and rehabilitating muscles

(76) Inventor: Georgette Constance Suttman, Houston, TX (US)

(21) Appl. No.: 12/653,580

(22) Filed: Dec. 16, 2009

(51) Int. Cl. A61H 23/00

(52) U.S. Cl. 601/111

(57) ABSTRACT

Apparatus and method for loosening and rehabilitating muscles including reciprocating at least two rows of at least four in-line extensions each row, against the weight of at least a portion of a body, the extensions preferably of a diameter of approximately three quarters of an inch, having a rounded top and separated by approximately one and a half inches.

### FIELD OF THE INVENTION

The invention relates to apparatus and method for loosening and rehabilitating muscles.

### BACKGROUND OF THE INVENTION

There is a universal need to loosen, soften, and release muscular tissue that has become tight, stiff, and contracted due to repetitive motion, over use, stress, and natural aging. However, currently there is lack of knowledge in the medical field on the effects of tight and contracted muscular tissue along with a void of automated devices that can perform this function and address that need. Muscular tissue and related muscular tightness, contractions, and nerve symptoms such as numbness and tingling, which is related to muscular tightness are unable to be x-rayed at this time in modern medicine. Muscles are considered soft tissue in anatomy and physiology and thus not dense enough to be portrayed on “x-raying” devices. This in turn makes it very difficult to diagnose and determine the extent of the problem. However, over the past 20 years of accumulated research, clinical trials, and direct personal experience with symptomatic characteristics of pain, injuries, limited range of motion, and debilitating quality of life directly related to and due to muscular degradation, the following invention is an apparatus and method for rehabilitating muscular tissue to serve this purpose.

Applicant's discovery is that the function and need is best served by a device that has pegs or extension devices with rounded, pyramid, and/or flat tips, organized in lines and palpitate up and down but may also be constant in a sustained position. The movement can be either simultaneous or alternating palpitating or without movement and constant. The up and down stroke can preferably be from ½″ to 2″ with approximately 40 to 70 strokes per minute. Diameter of the pegs or extension devices can be between 5/16″ to 1″ with an interior spacing of 1″ to 6″ and pegs or extension devices can be from 1″ to 4″ in length from the surface of the embodiment. If the pegs or extension devices are in a constant position, the pegs or extension devices can protrude from ½″ to 2″ from the surface of the preferred embodiment.

The apparatus can include one railing or set of two railings and up to six railings vertically with pegs or extension devices that can be removable from the railings or as a stationary part of the railings as the railings could be formed together with the pegs or extension devices. Preferably there are a set of two and up to a set of six pegs or extension devices having rounded, pyramid, and/or flat tips, being of 5/16″ to 1″ in diameter, and being separated by 1″ to 6″. Preferably the location of the pegs or extension devices on the railings are adjustable and able to be removed, but can be stationary on the railings. In preferred embodiment, each inline row would be attached to its own railings whether permanent or removable. The pegs or extension devices can also be independent of any railings and be directly connected to the motor and driven in that manner.

Preferably the motor is electric and attached above, under, or between a frame and placed in a preferred embodiment. The motor has small to medium DC current with low to medium RPM's and preferably the motor is structured to reciprocate the railings or if the pegs or extension devices are independent of railings while bearing up to 400 pounds of pressure weight. A singular or plurality of railings would be reciprocated simultaneously, although they could be reciprocated alternately or not move at all and be constant. The motor inside the preferred embodiment can be directly connected to the railings or the pegs or extension devices so that the motor drives the railings or pegs or extension devices up and down either simultaneously or alternatively. If the pegs or extension devices are utilized in a constant position, the motor needs to be strong enough to hole them in an extended position protruding from the surface of the embodiment. The motor activates a linear accuator, chassis or piston type driver of the up and down palpitating motion. The preferred embodiment utilized as the housing incorporates the railings, motor and frame. The intent is direct contact to muscular tissue for administering pressure and force that palpitates up and down or is constant without movement to rehabilitate variable states of muscular degradation, tightness, inflammatory levels, and pain conditions.

Testing has shown that treatment with such a device with the pressing pressure or the constant sustained pressure softens, loosens, and releases tight, stiff, and contracted muscular tissue more effectively than any manual or automated device available currently.

### SUMMARY OF THE INVENTION

### Description of Use

A device intended to loosen, soften, and release muscular tissue that has become tight, stiff, and contracted due to repetitive motion, over use, stress, and natural aging. The device will consist of an embodiment for the motorized pressing railings and pegs or extension devices and can be either a wedge, and/or massage chair, and/or massage table design.

If the wedge design option is used, the base unit may have two positions. One position is an upright wedge with pegs or extension devices protruding through the base unit from interior railings. The second position would be turning the wedge to the other angle which is less steep. The first position and second position have specific purposes and uses. Specific instructions for each position would be included for the user.

If the chair design option is used, preferably the base unit would be a recliner type model and have two variable positions. One position is an upright seated position with the pegs or extension devices protruding through the back and/or seat and/or leg rest. The second position would be a reclined position so that the user is horizontal with the floor and the pegs or extension devices would be protruding through the base unit through the back and/or seat and/or leg rest.

If the table option is used, preferably the base unit would be a recline and incline model and have variable positions. One position is flat with pegs or extension devices protruding from the ¼ top section and/or mid section and/or ¼ end section. A second position is ¼ top section inclined up while the remainder of the table is flat. The third position that same as above, but with the ¼ end section inclined. The fourth position is ¼ of the end position remaining inclined upward while the mid section and ¼ top section is flat. In any of the above position options, the pegs or extension devices would be protruding from the ¼ top section and/or mid section and/or end section.

### CHARACTERISTICS OF INVENTION

### Pressing/Plunger/Palpitating Motion Reciprocates Movement Up and Down

During 6 weeks of clinical trials, 67 patients of roughly the age range of 55 to 65 with lower back injuries were administered varying methodologies of standardized rehabilitation treatments which included physical therapy, traction, massage, stretching, exercise, and the pressing up and down method. The method that by far yielded the fastest and most dramatic results of decreasing pain and increasing flexibility in all participants was the palpitating up and down method. In up to 82% of the participants reported results after two forty five minute sessions

Constant Sustained Pressure of Pegs or Extension Devices without Movement

After a 4 year out patient research study consisting of 84 participants with chronic back pain complaints and symptoms, it was determined constant sustained pressure yielded the greatest difference in symptoms due to the increased amount of muscular loosening with a constant force on the muscles. When muscles reach a certain degree of tightness, heavy physical pressure has to be used to soften them and the most effective pressure is constant sustained. Because it takes longer to loosen muscles in this condition, the longer contact the muscle has with force, the faster they respond and release.

The Contact Pegs or Extension Device could be Removable or Fixed and could be Variable Sizes Between 1″ to 4″ in Length

Laboratory research has demonstrated that variable sized lengths of pegs or extension devices used on patients in a 6 month controlled experiment confirmed that there was not a “standard” one size fits all. Rarely were there two patients with exactly the same degree of tightness and injury. Even patients that were the same age and build produced variable symptoms with the same injury complaint. In conclusion, patients muscular condition have to be individually evaluated and the appropriate length of pegs or extension devices used in order to gain the desired results of loosening and releasing the muscular tissue causing the pain and/or injury.

The Contact Pegs or Extension Devices could be Variable Sizes from 5/16″ to 1″ in Diameter

In 3 clinical surveys lasting 9 months, 58 patients ranging in age from 46 to 60 with shoulder tension and upper back tightness were administered the pressing method with pegs or extension devices with varying diameters. Shoulder and upper back muscles are large muscle groups so the 5/16″ pegs or extension devices were not effective after two weeks of testing. Once patients were administered pressing with pegs or extension devices of larger diameter such as ½″ to 1″, the results were apparent in 3 days. The conclusion was drawn that the muscles of a particular size needed appropriate sized pegs or extension devices in order to penetrate effectively. The appropriate penetration yielded the desired results quickly and effectively confirming that variable diameters were essential in making muscular tissue respond.

The Contact Pegs or Extension Devices could be Separated by 1″ to 6″ Apart

In dissecting laboratory cadavers, it was confirmed that most muscular tissue runs along vertical patterns so spacing became an important factor is research trials when determining peg or extension device location. The determination of vertical alignment for the pegs or extension devices had already been confirmed, but horizontal spacing became essential after a 12 month study on patients of normal build, in the age range of 48 to 62, with varying degrees of muscular tightness in the hamstring and gastrocnemius muscles or back of the legs. The muscular tissue of the targeted areas demonstrated variable responses when pegs or extension devices of variable distances were utilized. Patients had a wide range of muscular development in the targeted areas depending on their athletic levels so this demonstrated the need for being able to separate the pegs or extension devices accordingly. The more muscular developed group needed wider separation while the less muscular developed group gained results with closer separation of the pegs or extension devices.

Travel Length Up and Down could be from ¼″ to 2″

Using 8 groups of 6 patients in each with a 22 months study, it was determined that travel length out of the surface of the preferred embodiment which in this case was the wedge design, patients gained very little results if the pegs or extension devices traveled less than ¼″ out of the surface. It was also determined that patients gained very little results if the pegs or extension devices traveled greater than 2″ out of the surface.

Thus the range of ¼″ to 2″ was established as the most effective range. While a marginal number of patients received negligible results outside the effective ranges, it was noted, but not established as significant to effectiveness.

The Contact Pegs or Extension Devices could Palpitate at the Simultaneous and/or Alternate

After 3 years of experimentation with over 128 patients in a clinical environment, it was determined that there was a need for variable manners of pressing options consisting of simultaneous pressing and alternating pressing. Patients with higher levels of inflammation discerned better tolerance to pressing treatment when administered alternatively while patients with lower levels of inflammation could tolerate pressing treatment longer with simultaneous movement. In order to gain favorable results, patients need to be have pressing however, if they could not tolerate the pressure or force then they would not continue the pressing due to the discomfort. By determining the need for two distinct treatment methods, the patient was able to continue with the experiment so documented results could be captured. Progress on the desired results were consistently positive once the appropriate method of either simultaneous or alternating pressing were administered to patients.

The Contact Pegs or Extension Devices could Protrude from Railings or Directly from the Motor

In an internal study with 6 professionally trained therapists that understand the pressing rehabilitation device over a period of 8 months tested the options of having the pegs or extension devices extending directly from the railings and from the motor. Each presented a small variable difference in the contact application however, both methods were effective and considered equal and compatible with the desired results.

Able to Demonstrate Continuous Movement with Weight Up to 400 lbs. on Pegs or Extension Devices and Have the Capacity to Run for Many Continuous Hours without Over Heating the Motor

In a study group of 28 participants ranging from 200 up to 450 lbs for a period of 6 months were asked to sample the pressing rehabilitation device for various periods of time in order to determine if the motor would continue to be strong enough, continue to operate, and not burn out under these extended conditions. The time variations ranged from 1 hour to 12 consistent hours in which it was never turned off and it was a consensus that this time frame would encompass the majority to usage time by the majority of users.

Powered with a Variable Speed Motor to Achieve Approximately 40 to 70 Strokes Per Minute

A variable speed motor was determined to be the most effective type of driving force to achieve the desired up and down palpitating pressing movement in order to create the number of pressing strokes per minute. After over 7 years of clinical experience, it is established that the most effective range for the most effective result was between 40 to 70 strokes per minute. Experiments outside these ranges yielded very little results and became ineffective in 92% or participants.

Multiple Holes or Multiple Locations are Needed on Railings for Pegs or Extension Devices in Order to be Adjustable in Desired Treatment Areas and Multiple Positions for Pegs or Extension Devices Without Railings in Order to be Adjustable in Desired Treatment Area

After over 10 years of muscular location research, there was a need to have the ability to move the pegs or extension devices to various locations in order to accommodate the majority of muscles located throughout the human body. The areas of most importance was determined by research survey results indicating the most common pain and dysfunction areas reported by over 1,262 surveyed. The pegs or extension devices were tested both located directly on the railings and directly driven by the motor without the railings. As long as there were multiple location options utilized, both the pegs or extension devices located directly on railings or directly driven by the motor yielded comparable effectiveness.

### BRIEF DESCRIPTION OF DRAWINGS

A better understanding of the present invention can be obtained when the following visual drawings are considered in conjunction with the following description of those drawings:

FIG. 1 is the view of the motor looking downward or inward. The motor would be the driver of the palpitating motion or sustained constant position in which preferred embodiment is used. The railings can vary from two sets up to six sets or independent pegs or extension devices directly driven by the motor without railings. The holes in each railing would be the location of the pegs or extension devices. The pegs or extension devices may also be made as part of each railing and not removable and thus would be in the same locations. These railings may move up and down at the same time or may alternate or may be in a constant sustained position. The pegs or extension devices may move up and down without railings in which they would be directly driven by the motor either alternating or simultaneous or may be held in a constant sustained position. The motor would be a DC mechanical and would drive a piston option, actuator option, or chassis option. The motor would be above, under or between the railings and/or pegs or extension devices depending on the type of preferred embodiment and would drive the movement with pressure and force to enable the pegs or extension devices to extend from the embodiment.

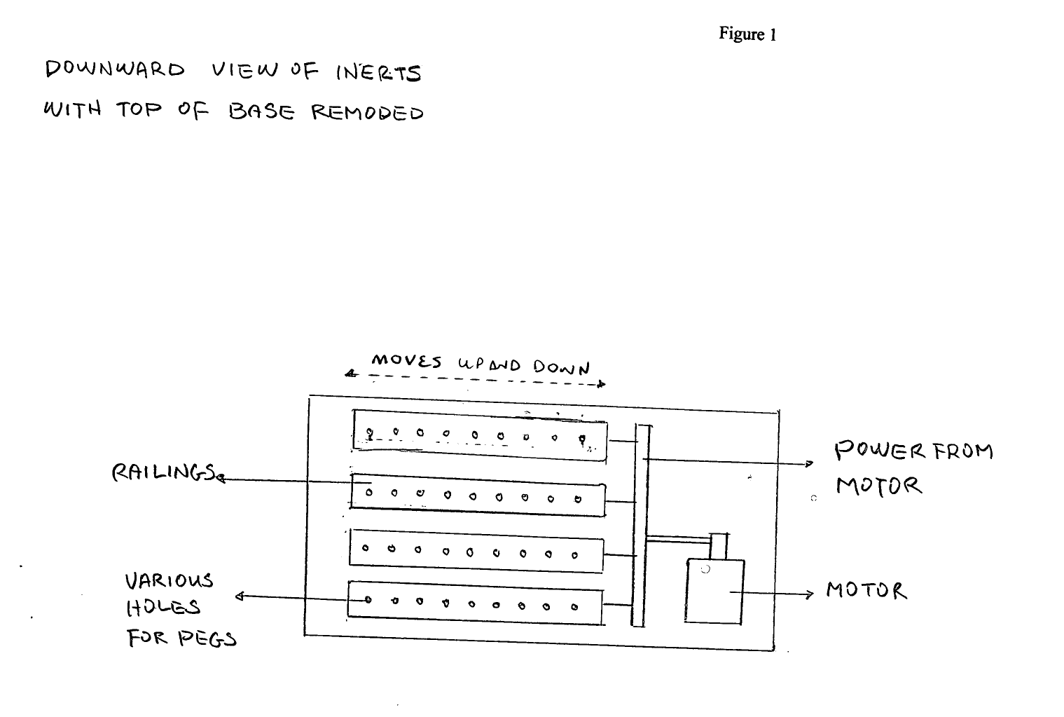

FIG. 2 is the view that depicts the framework of the inside of the wedge embodiment with the motor, pegs or extension devices, and railings. The pegs or extension devices would be arranged in such a manner along the length of the railings. This is an example of the positions the pegs or extension devices could have, but may or may not be utilized all at the same time. The railings in this example would move up and down with either a chassis, actuator, or piston driven by a DC motor. Two railings are demonstrated here, but up to 6 could be utilized. However, the pegs or extension devices may also be directly attached to the motor without railings and driven by an extension means to create the up and down movement just depending on the particular motor installed in the preferred embodiment. The motor can be made larger or smaller depending on what preferred embodiment is used in order to have the necessary power to drive the palpitating movement.

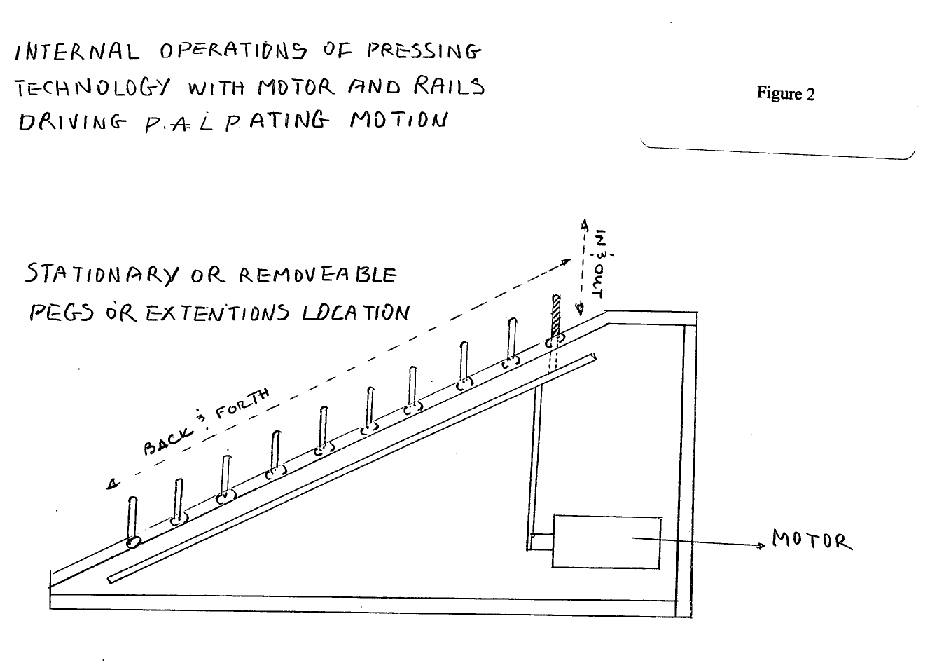

FIG. 3 is the simplified view of the embodiment of the wedge option. The wedge is in the standard upright angled position in which the user would lay against it with the back and neck. The measurements are accurate to scale. This design would support the cranium while the pegs or extension devices protruding from the interior would perform the palpitating motion up and down or be in a constant sustained position. The wedge would rest on the floor, bed, or couch while the user leans against it using body weight for pressure against the pegs or extension devices. The wedge may also be turned over with the exterior view becoming the point of contact with the floor, bed, or couch and due to the wedge shape and measurements, would administer a different type of pressure and angle thus resulting in additional loosening benefits. This would accommodate different areas of the body and additional muscle groups.

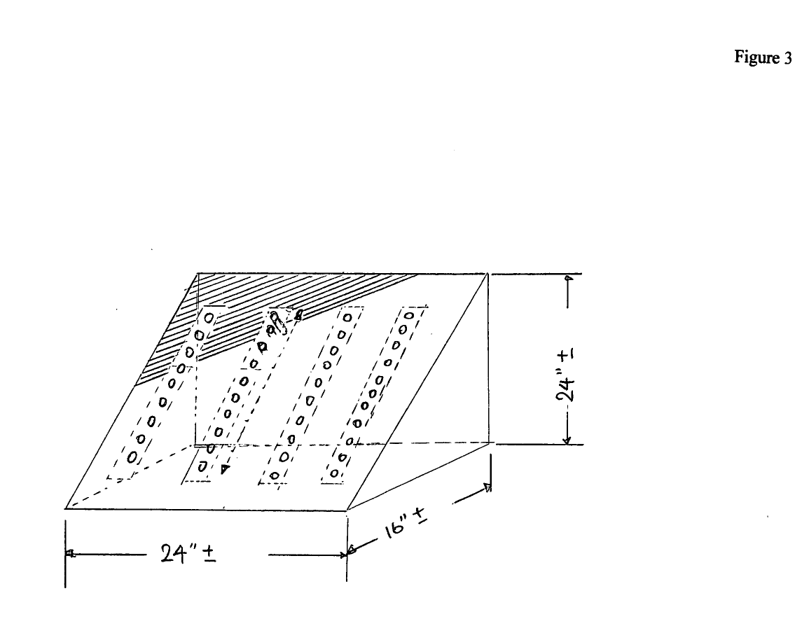

FIG. 4 is the simplified view of the embodiment of the chair option. The chair is in the upright sitting position and the motor(s) and pegs or extension devices are illustrated in the possible position locations. The top of the chair can recline down and the bottom can incline up in a secondary perpendicular position. All the pegs or extension devices may be utilized as shown or a combination of locations may be utilized.

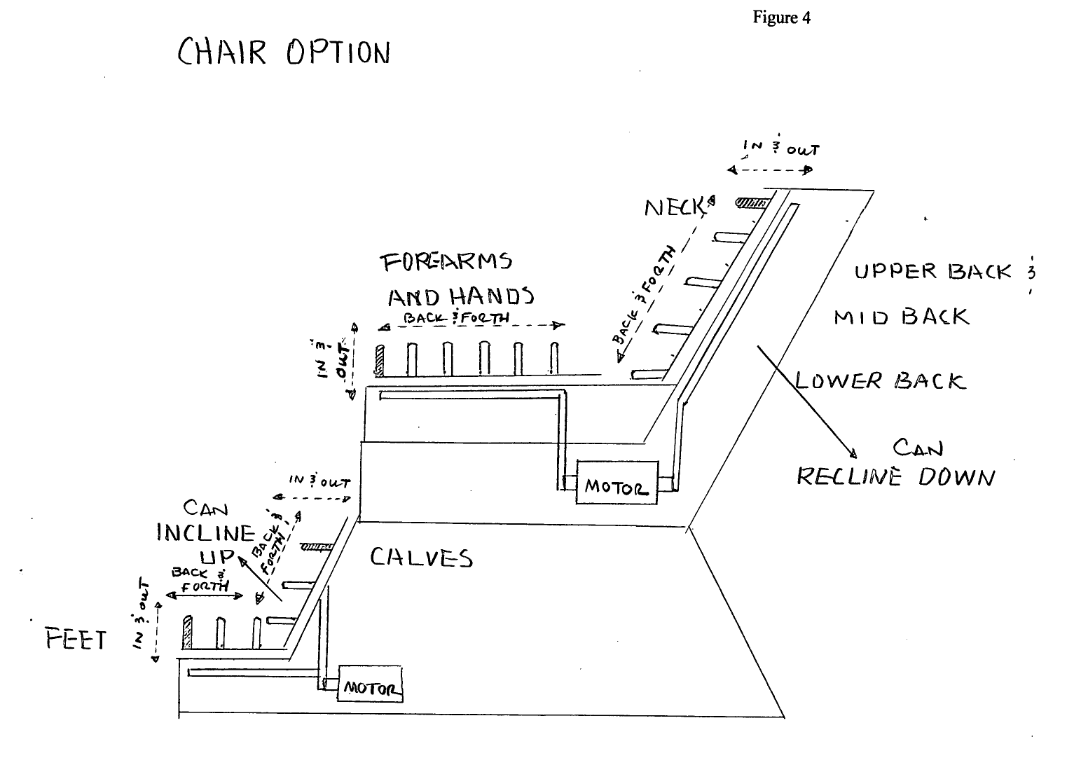

FIG. 5 is the simplified view of the embodiment of the table option. The table can be utilized in multiple positions. The motor(s) and pegs or extension devices are illustrated in the possible positions.

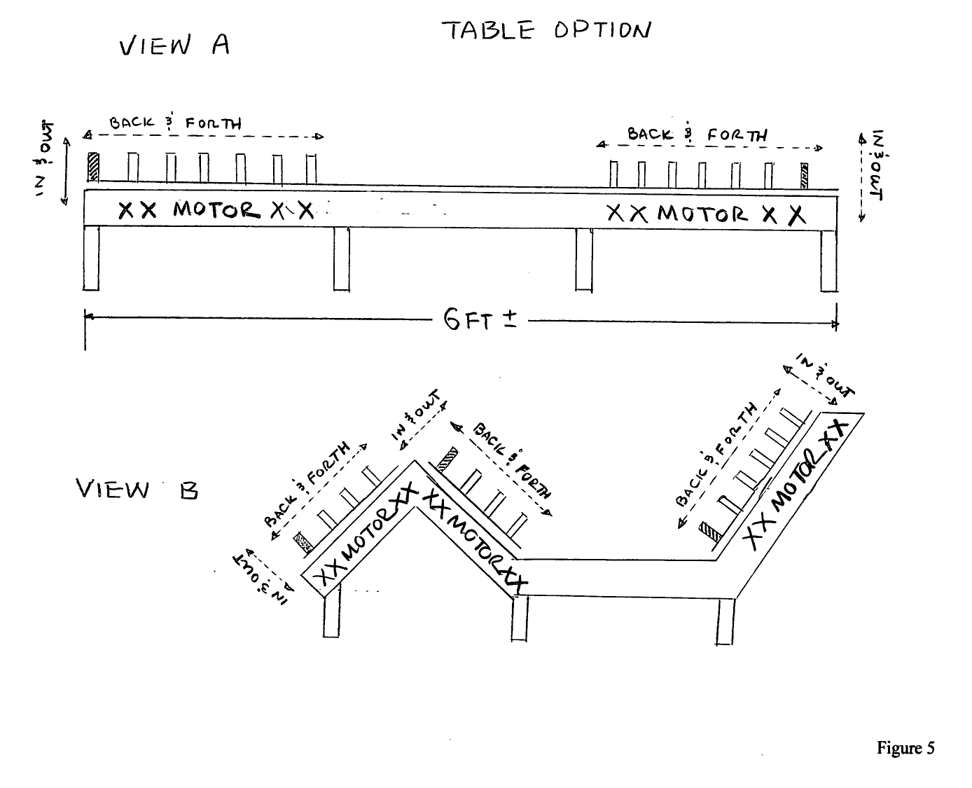

The measurements are accurate to scale and the “View A” and “View B” can each be utilized for contacting various muscular tissue. All the pegs or extension devices may be utilized as shown or a combination of locations may be utilized.

FIG. 6 is the view of the pegs or extension devices which may be of varying shapes. The length and diameter may vary and used either simultaneous or alternating or in a constant sustained fashion. The two examples are 2½″ and ¾″ however, the pegs or extension devices diameter may vary from 5/16″ to 1″.

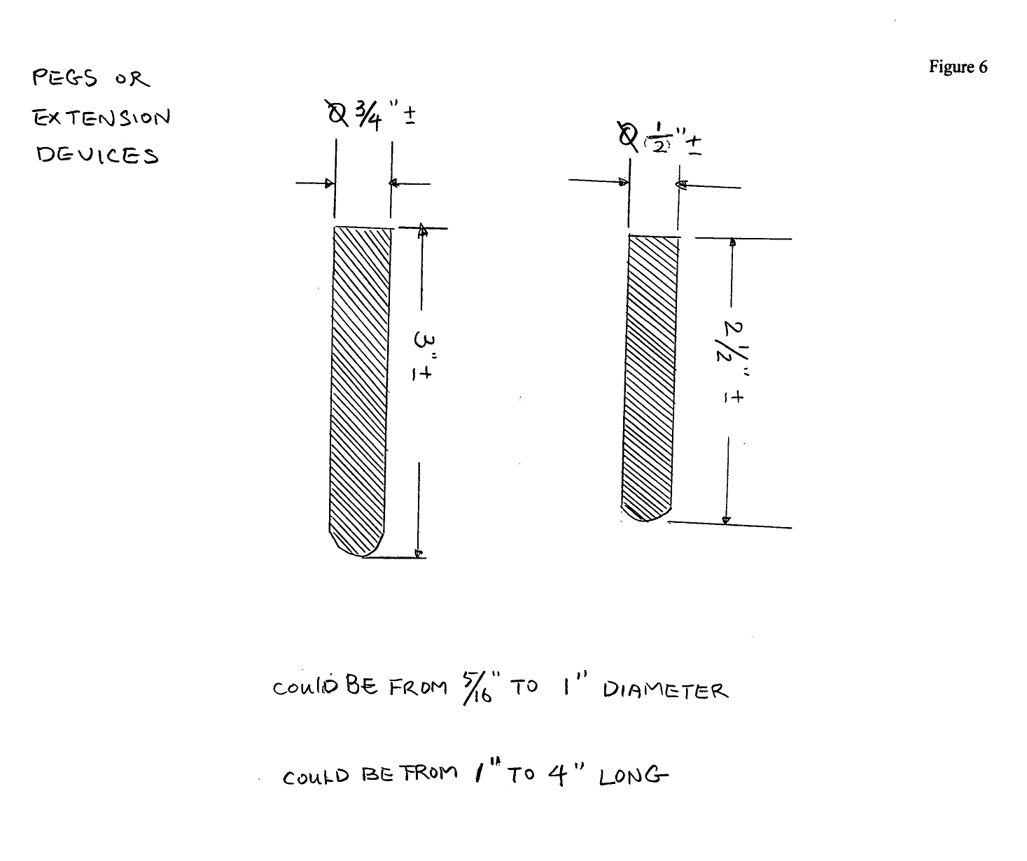

All drawings are primarily illustrative. It would be understood that structure may have been simplified and details omitted in order to convey certain aspects of the invention. Scale may be sacrificed for clarity.

What is claimed is:

1. Apparatus for muscle loosening and rehabilitation, comprising:
a housing having a plurality of extensions, one inch to four inches long, 5/16 inch to one inch in diameter, spaced ½ inch to six inches apart; attached to said housing for reciprocating motion therefrom; and
a motor attached and to the extensions for providing said reciprocating motion, said reciprocating motion having a stroke length of ¼ inch to two inches and a repetition of forty strokes to seventy strokes per minute.

2. The apparatus of claim 1 wherein the extensions are reciprocated synchronously.

3. The apparatus of claim 1 wherein the extensions are affixed to a rail and the motor is structured to reciprocate the rail with respect to the housing.

4. The apparatus of claim 1 wherein the extensions are pegs, adjustably attachable to a rail.

5. The apparatus of claim 4 that includes at least two rails having at least four inline pegs each.

6. The apparatus of claim 4 including a plurality of attachable pegs of different lengths.

7. The apparatus of claim 4 including a plurality of attachable pegs of lengths one inch, two inch and three inches.

8. The apparatus of claim 1 including a plurality of attachment positions for an extension on the housing.

9. The apparatus of claim 1 including a frame and a housing for the motor and housing.

10. The apparatus of claim 1 wherein the extensions have rounded, flat or pyramidical ends.

11. A method for muscle loosening and rehabilitation, comprising:
supporting a portion of a human body on at least two rows of at least four inline extensions attached to a housing, the extensions having a length of approximately one inch to four inches, a diameter of approximately 5/16 inch to one inch, and being separated by at least ½ inch to six inches; and
reciprocating the extensions against a weight of the body portion, for a stroke of ¼ inch to two inches approximately 40 to 70 strokes per minute.

12. The method of claim 10 that includes reciprocating the extensions synchronously.

13. The apparatus of claim 1 wherein the housing is structured to support portions of the human anatomy.

14. The apparatus of claim 1 wherein the housing comprises a table and a chair.
